(19) United States
(12) Patent Application Publication
(10) Pub. No.: US 2025/0262644 A1
(43) Pub. Date: Aug. 21, 2025

(54) HIGH-DENSITY DIRECT-TO-DESTINATION OUTPUT SYSTEM

(71) Applicant: National Presort, LLC, Fort Worth, TX (US)

(72) Inventors: Brent Daboub, Dallas, TX (US); Joshua Owens, Prosper, TX (US); Timothy Stashluk, Arlington, TX (US); Michael Hake, Lewisville, TX (US); Federico Ayala, Grand Prairie, TX (US)

(21) Appl. No.: 19/058,944

(22) Filed: Feb. 20, 2025

Related U.S. Application Data
(60) Provisional application No. 63/555,466, filed on Feb. 20, 2024.

(51) Int. Cl. B07C 3/06; B65G 11/02; B65G 47/48

(52) U.S. Cl. CPC B07C 3/06; B65G 11/023; B65G 47/485; B65G 2203/0216

(57) ABSTRACT

A high-density output system includes a package chute having a selected slope, the package chute including a plurality of apertures and a bottom end, a frame configured to carry the package chute, the frame having an open area disposed below the package chute, and a plurality of flaps, each flap being associated with one of the plurality of apertures. A plurality of holders are substantially disposed in the open area below the package chute and a plurality of sensors are coupled to the package chute. Each holder is operably associated with at least one of the plurality of apertures or the bottom end of the package chute and each flap is configured to be opened at a selected time, such that a package is directed through the associated aperture and into the respective holder.

### CROSS-REFERENCE TO RELATED APPLICATIONS

This application claims the benefit of U.S. Provisional Application No. 63/555,466, filed Feb. 20, 2024 and entitled “High-Density Direct-to-Destination Output System.

### FIELD OF INVENTION

The invention relates to package sorting systems, and in particular, the invention relates to a direct-to-destination output system designed to route packages from a conveyor system to a selected destination.

### BACKGROUND OF THE INVENTION

Generally, sortation equipment is used to increase efficiency during the process of moving packages from one location to another. Sortation equipment often includes a conveyor belt type system in which packages are routed to storage locations based on the desired end destination. Such storage locations are generally sacks, bins, containers, or other similar pieces of equipment capable of storing a number of packages.

A tracking system is also generally associated with the shipping process, such that each individual package location can be determined in real-time, so as to move the package in a desired manner. When loaded on a conveyor system, a package is moved until it reaches a point associated with a selected storage location, at which point a device will move the package from the conveyor system into the proper storage location. Each storage location, whether it be a bag, bin, container, or other structure, is then unloaded or moved to an additional location for further progressing through the shipping process.

Although the aforementioned systems for sorting packages represent great strides in the field of output systems, many shortcomings remain.

### SUMMARY OF THE INVENTION

In one aspect, a high-density output system includes a package chute having a selected slope, the package chute including a plurality of apertures and a bottom end, a frame configured to carry the package chute, the frame having an open area disposed below the package chute, and a plurality of flaps, each flap being associated with one of the plurality of apertures. The system further includes a plurality of holders substantially disposed in the open area below the package chute and a plurality of sensors coupled to the package chute. Each holder is operably associated with at least one of the plurality of apertures or the bottom end of the package chute, and each flap is configured to be opened at a selected time, such that a package is directed through the associated aperture and into the respective holder.

In another aspect, a system for sorting packages includes a conveyor system for transporting packages and a plurality of output systems. Each output system includes a package chute having a selected slope, the package chute including a plurality of apertures, a frame configured to carry the package chute, a plurality of flaps, each flap corresponding to one of the plurality of apertures, a plurality of sack holders operably associated with the package chute, and a plurality of sensors, at least a portion of the sensors being operably associated with the plurality of flaps. Each output system is angled relative to the conveyor system such that packages on the conveyor system are transferred to one of the output systems.

In another aspect, a method for sorting packages includes providing a conveyor system and providing at least one output system. The output system includes a sloped package chute including a plurality of apertures, a frame configured for carrying the sloped package chute, a plurality of flaps, each flap being operably associated with one of the plurality of apertures, a plurality of sack holders operably associated with the package chute, and a plurality of sensors coupled to the package chute. The method further includes providing a plurality of sacks, each sack having a designated sortation category, each sack being placed on one of the sack holders, providing at least one package to a starting portion of the conveyor system, the at least one package having an end destination associated with one of the designated sortation categories, directing the package to one of the at least one output systems based upon the end destination, and actuating motion of one of the plurality of flaps based upon an output from the plurality of sensors, such that the flap moves into an open position and the associated aperture is exposed, such that the package is directed downward into the associated sack.

### DESCRIPTION OF THE DRAWINGS

The novel features believed characteristic of the invention are set forth in the appended claims. However, the invention itself, as well as a preferred mode of use, and further objectives and advantages thereof, will best be understood by reference to the following detailed description when read in conjunction with the accompanying drawings.

FIG. 1 is a perspective view of an output system.

FIG. 2 is a side view of the output system of FIG. 1.

FIG. 3 is a front view of the output system of FIG. 1.

FIG. 4 is a top view of the output system of FIG. 1.

FIG. 5 is a cross-sectional view of the output system taken along line A-A of FIG. 3.

FIG. 6 is a perspective view of a package sorting system utilizing a plurality of the output systems of FIG. 1.

FIG. 7 is a partial exploded view of a flap for use with the output system of FIG. 1.

While the assembly of the embodiments is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the embodiments as defined by the appended claims.

### DETAILED DESCRIPTION

Illustrative embodiments of the high-density direct-to-destination output system are described below. In the interest of clarity, not all features of an actual implementation are described in this specification. It will, of course, be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

Reference may be made herein to the spatial relationships between various components and to the spatial orientation of various aspects of components as the devices are depicted in the attached drawings. However, as will be recognized by those skilled in the art, the devices, members, apparatuses, etc. described herein may be positioned in any desired orientation. Thus, the use of terms such as “above,” “below,” “upper,” “lower”, or other like terms to describe a spatial relationship between various components or to describe the spatial orientation of aspects of such components should be understood to describe a relative relationship between the components or a spatial orientation of aspects of such components, respectively, as the device described herein may be oriented in a variety of desired directions.

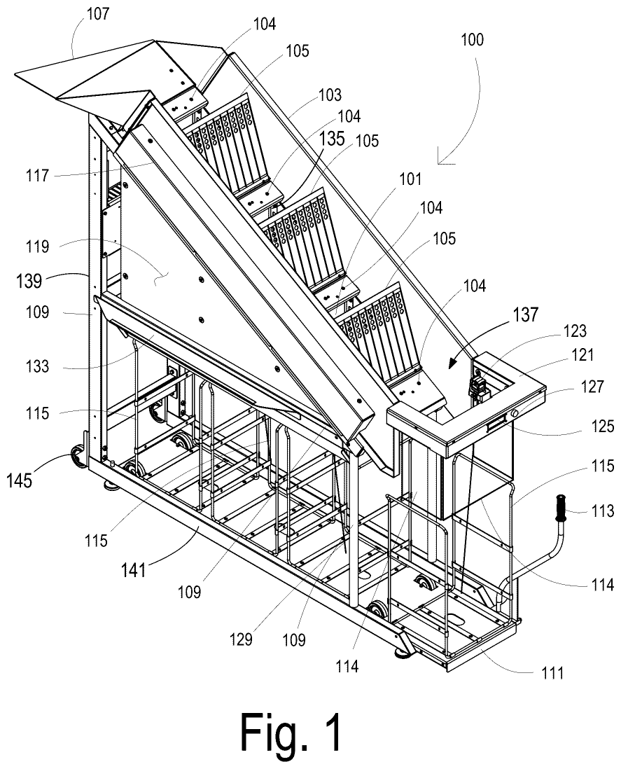

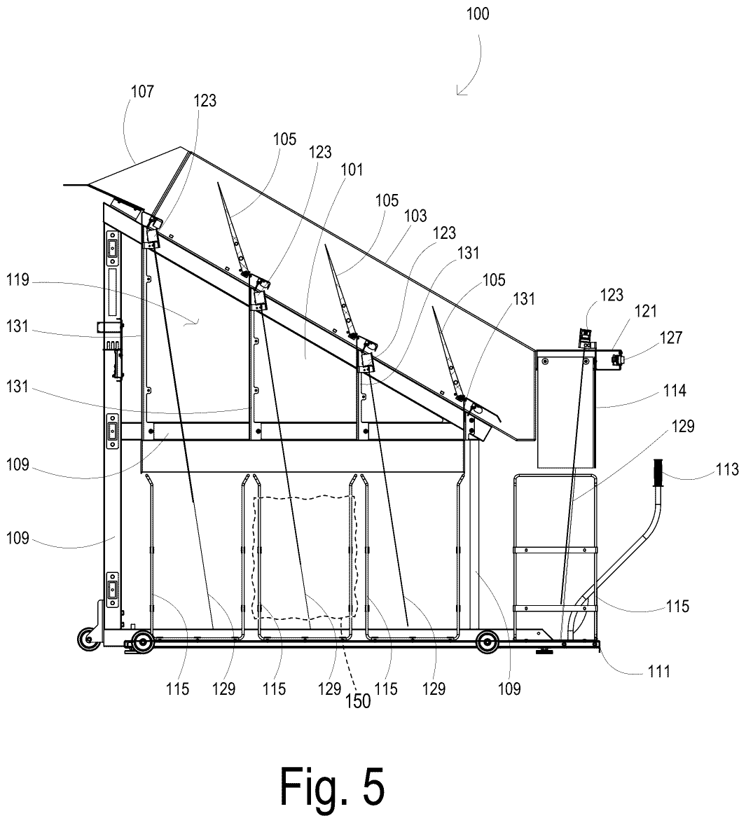

Referring now to FIG. 1, a perspective view of a high-density direct-to-destination output system is illustrated according to an embodiment. Output system 100 is preferably configured to direct packages from a conveyor-type system into selected sacks 150 (a representative example is shown in FIG. 5). Although a conveyor-type system is preferred, it should be appreciated that there are other embodiments that may be compatible with additional package sorting systems that do not operate with a primary conveyor. Further embodiments may utilize a variety of sorting systems to send packages to various destinations, such as containers, bins, or other package holding destinations.

In the illustrated embodiment, output system 100 includes a sloped package chute 101, which includes a pair of opposing, upstanding side walls 103. The upstanding side walls 103 are configured to aid in package retention on the chute; however, other embodiments may include different walls varying in size, shape, and material. For example, some embodiments may include curved walls; additional embodiments may include cushions on the walls to aid in package damage prevention. The package chute 101 also includes a plurality of apertures or openings 135 sizably configured to fit selected packages through. Each aperture 135 corresponds to one of a plurality of flaps 105, which are configured to be selectably opened and closed when a certain package is intended to pass through a respective aperture 135. In the illustrated embodiment, the system includes three flaps 105, each flap corresponding to one of the apertures 135; however, it should be appreciated that other embodiments may include varying amounts of flaps and associated apertures. In operation, it is preferred that each flap 105 will open upward when desired, such that a backboard effect is created by the flap to aid in directing a selected package downward through the respective aperture 135. It should be understood that FIG. 1 illustrates all three flaps 105 in an opened position and therefore causing all three associated apertures 135 to be exposed; however, during operation of the system, the flaps will generally be in a closed position with one flap 105 opening at a desired time to direct a package down through one of the apertures 135 in the package chute 101.

Package chute 101 preferably includes a plurality of sensor bars 104. Each sensor bar 104 is disposed in a position slightly above a respective aperture 135/flap 105 on the package chute 101, with one sensor bar 104 disposed near a bottom end or outlet 137 of the package chute 101. Such positioning allows for a package to pass over the sensor bar 104 prior to reaching the respective aperture 135. When a leading edge of a package is detected by a selected sensor bar 104, the appropriate flap 105 is actuated to provide access to the respective aperture 135. When the trailing edge of the package is detected by that same sensor, the appropriate flap 105 is closed. By utilizing sensor bar 104 to read the package leading and trailing edges, the system efficiency is maximized by preventing unwanted delays from flaps being held open for longer than necessary. In the illustrated embodiment, sensor bars 104 include a plurality of retro-reflective sensors; however, it should be appreciated the other embodiments may utilize varying numbers, positioning, and type of sensors while maintaining the goal of system efficiency maximization. In even further embodiments, there may not be a one-to-one ratio of sensor bars to flaps/apertures. In such embodiments, a sensor bar or multiple sensor bars may be paired with timing software to estimate time of arrival of a package to each flap and then cause desired flap actuation.

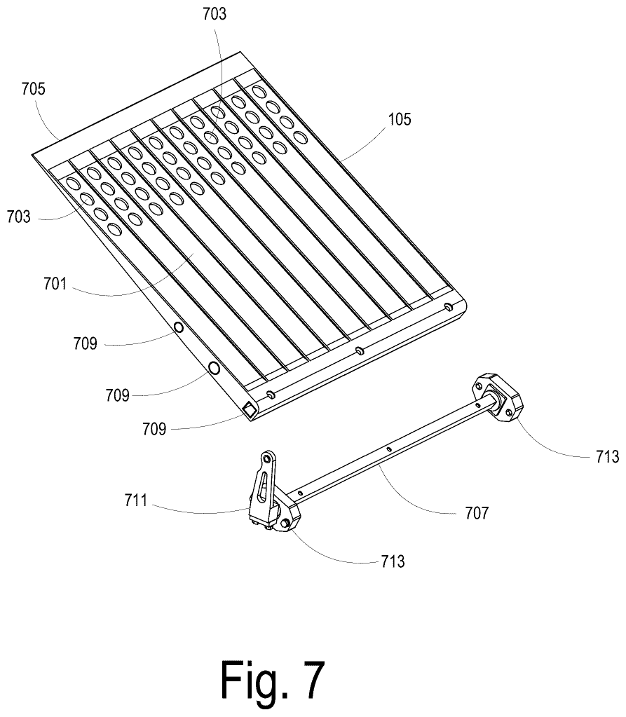

Flaps 105 are preferably manipulated using actuators disposed on a portion of either the package chute 101 or the supporting frame. Flaps 105 are preferably configured to act as a single gate that selectively flips up when actuation is caused due to sensor bar 104 readings. It should be appreciated that various embodiments may not be a single gate, but rather a twin-gate or even further gate options all configured to direct packages to a selected location. Actuation of the flaps may be accomplished through the use of a variety of electrical, mechanical, or pneumatic devices. For example, a series of axels, bushings, shafts, and fasteners, all being of various shapes and sizes may be utilized to actuate the flaps. Flap 105 detail is further provided in FIG. 7 and the related descriptive paragraphs.

Package chute 101 is preferably carried and supported by a frame 109. Frame 109 is preferably defined by a plurality of vertical support members 139 and horizontal support members 141. The vertical support members 139 are of different heights, so as to account for the slope of the package chute 101. The horizontal support members 141 provide support to the system by connecting to and maintaining a consistent structure with the vertical support members 139. In the illustrated embodiment there is a pair of upper horizontal support members extending between the top of the shorter vertical support members to a middle section of the taller vertical support members. There is also a pair of lower horizontal support members extending between the bottom portion of the vertical support members. In some embodiments, there may be a pair of diagonal support members defining and supporting the slope of the package chute 101. The lowermost horizontal support members may have some combination of legs/feet/support members 143 for holding the system in place. Additionally, the support members may include one or more wheels 145 configured to aid movement of the system when required.

In the illustrated embodiment, the system 100 further includes a rolling cart 111. In some embodiments, the lowermost horizontal support members may include a track/guide structure for purposes of guiding the rolling cart 111. Rolling cart 111 includes a handle 113 and a plurality of sack holders 115. Rolling cart 111 is preferably carried by wheels 147 on a bottom edge, such that the cart can conveniently be pulled out from underneath the package chute 101 when a sack needs to be emptied or replaced. In the illustrated embodiment, the first sack closest to the handle may be changed without having to remove the rolling cart 111 from under the package chute 101. It should be appreciated that further embodiments may include varying systems and methods for exchanging the sacks or sack contents, including the possibility that the sacks may be changed without the need for a rolling cart.

Although it is preferred that a single ergonomic handle 113 is used to maneuver rolling cart 111, it should be appreciated that other embodiments may include other handle options. For example, there may be a second handle, or even further additional handles, connected to the rolling cart 111 for aiding in desired manipulation of the cart. In further embodiments, there may be devices used for movement of rolling cart 111, such that no handles are necessary. For example, in at least one embodiment, the system is automated such that the pushing of a button or pulling of a lever activates the system to cause movement of the rolling cart 111. In even further embodiments, the cart 111 does not have wheels, but rather slides along a track system or some other similar method of controlled movement.

In the illustrated embodiment, the rolling cart 111 includes four sack holders 115, the sack holders 115 being aligned such that they are disposed in a position substantially beneath package chute 101. The sack holders 115 are configured to each hold a bag/sack designed to carry packages. By positioning sack holders 115 beneath chute 101, packages are selectively dropped through the apertures 135 in the chute 101 or off the bottom end 137 of the chute 101, and into the proper sack for sorting. Under the illustrated embodiment, the sack holders 115 are positioned such that three of the four are beneath a respective aperture 135 and flap 105, and the fourth is positioned near the bottom end 137 of chute 101. Each of the apertures 135 and the bottom end 137 of chute 101 are considered to be package drop points. It should be understood that further embodiments may include alternative layouts, with varying numbers of sack holders, positioning of the sack holders, and even orientation of the sack holders.

Near the outlet 137 of the package chute 101 is end frame 121. End frame 121 is preferably U-shaped with the open end of the end frame 121 facing the package chute 101. A set of end flaps 114 preferably extend downward from end frame 121 arranged to be an extension thereof, so as to create an end barrier near the outlet 137 of package chute 101. End flaps 114 are preferably made from a vinyl material, but some embodiments may include flaps of varying material. Additionally, although end flaps 114 are shown as three rectangular pieces positioned in a U-shaped configuration near the outlet 137 of package chute 101, it should be appreciated that other embodiments may utilize elements of different shape and size, while maintaining the purpose of directing packages downward into a sack holder.

The end frame 121 also preferably includes a sensor 123, a display 125, and a status light 127. The sensor 123 is positioned on an interior surface of end frame 121, such that the sensor is capable of detecting the contents of a sack (not shown) disposed in a position below the end frame 121. Additional sensors may be placed in positions around the system 100, such that the contents of each sack beneath a selected aperture 135 is sensed. Such additional sensors 123 are best illustrated in FIG. 5. In the illustrated embodiment, the sensors 123 are laser sensors; however, it should be appreciated that any series or combination of laser, proximity, distance, weight, volumetric, or other similar sensors may be utilized.

Beyond sensing of the sack contents, further sensors may be positioned and configured for varying roles; for example, some sensors may be configured to detect and track selected package movement through the system, while other sensors may be utilized to detect the position state of each flap. It should be appreciated that sensor function may be uniquely customized within each embodiment to meet specific needs or desires.

The display 125 and the status light 127 may include various information and indicators configured to alert a user of the system 100 when certain events occur. For example, in some embodiments there may be a specific color status light 127 to indicate when the system is operational; in some embodiments, there may be a different color illuminated when the system has an error or is not operational for any reason. In further embodiments, there may be additional lights, displays, and/or indicators configured to provide necessary operational information regarding the system. Although a variety of indicators and displays are possible on various embodiments, it should be appreciated that some embodiments may not include any displays or status indicators.

A cover 117 is disposed on an external surface of at least one of the side walls 103. In the illustrated embodiment, the cover 117 is a molded piece of material configured to contain and protect actuators that are used to operate the flaps 105 and any associated wiring. Although illustrated as one long molded piece, it should be understood that in other embodiments, the cover may be sized and shaped in various ways. For example, in some embodiments, the actuators each have its own individual cover, while the wiring is either open or contained in a smaller strip of cover between each individual cover. In further embodiments, the cover may be integrated into the side wall with additional equipment, such as the sensors 123.

The frame 109 further includes a pair of walls 119 are coupled to frame 109. In the illustrated embodiment, the walls 119 are triangle-shaped, each being disposed on one side of the upper portion of the frame, such that the area between the apertures 135 of the package chute 101 and the top of sack holders 115 is substantially enclosed so as to protect from packages falling out of the side of output system 100. To further aid in directing packages to the correct sack holder 115, the illustrated embodiment includes a series of dividers 131, best seen in FIG. 5, vertically positioned in front of and behind each aperture 135. The walls 119 and dividers 131 define a substantially enclosed area associated with each aperture 135 to aid in directing packages from the aperture 135 into the proper sack. Although illustrated as being substantially planar, it should be understood that the walls 119 and the dividers 131 may include directing segments. For example, a wing portion may be utilized near the bottom of walls and/or dividers, also near the top of sack holders 115, such that packages are directed from the outer regions under the chute toward the center, so as to maximize accuracy of packages reaching the proper sack holder 115. Such wing portions may be integral with the walls or dividers, or may be a separate attachment for the system.

Frame 109 also includes at least one bumper 133. The bumper 133 is configured to provide a buffer of space if multiple output systems 100 are integrated into a system. Although shaped as a long, thin projection from one side of the frame, it should be appreciated that the bumper may take on a variety of shapes, sizes, and materials, all with the goal of providing safe and efficient operation of multiple output systems next to each other. In some embodiments, there may be multiple bumpers, either being on the same side, or on opposing sides of the system. Optional padding or cushioning may be added to the bumper(s) in some alternative embodiments.

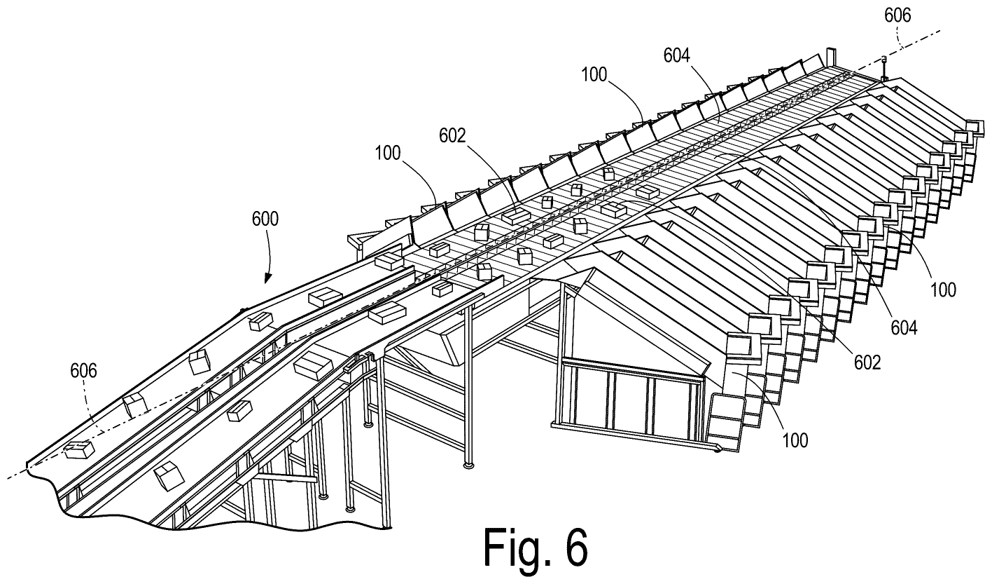

Referring in part to FIG. 6, in operation of the illustrated embodiment, packages 602 are directed from a conveyor belt 604 of a package sorting system or conveyor system 600 onto the package chute 101 using a transfer plate 107. The transfer plate 107 is an angled piece of stainless steel that aids in shifting package motion from the conveyor belt 604 onto the package chute 101. It is desirable to minimize damage to any packages 602 during sorting. As such, in the illustrated embodiment, the package chute 101 is angled at approximately 68 degrees relative to a longitudinal axis of the conveyor system 606, such that there is an approximately 22-degree side offset from a perpendicular position. The angled positioning of the package chute 101 ideally provides for the package 602 to be shifted from the moving conveyor belt 604 over the transfer plate 107 and onto the package chute 101 without a harsh slamming of the package into the side wall of the chute. It should be appreciated that some embodiments may utilize a variety of chute offset angles to meet desired functionality based on various factors such as package and/or conveyor movement speed and system size. Although some level of side offset is utilized in the illustrated embodiment, it should be appreciated that some embodiments may utilize at least one output system exactly perpendicular to a conveyor, or another package sorting system. It should be further appreciated that some embodiments may utilize a type of cushioning effect on the interior surface of the side walls, such that risk of package damage upon collision with the side walls of the package chute is minimized.

After being directed from the conveyor belt onto the package chute 101, each package is then directed to one of four unique locations, each location being one of the four sacks held by the sack holders 115. The preferable combination of apertures 135, flaps 105, and end flaps 114 are used to selectably direct packages into the desired sack. Any number of output systems 100 can be disposed along a common conveyor system, such that a plurality of unique destination sacks may be utilized in a single sorting operation, as shown in FIG. 6. In one embodiment of the invention, the sacks are provided and each sack has a designated sortation category. Each package 602 may have an end destination associated with one of the designated sortation categories associated with the respective sack. The sorting system 600 directs the package 602 to the appropriate output system 100 based upon the associated end destination. Actuating motion of one of the flaps 105 of the output system 100 based upon an output from the associated sensor 123 moves the flap 105 into an open position and the associated aperture 135 is exposed. Thereby, the package 602 is directed downward into the associated sack.

At any point during the sorting operation, a sack may need to be changed. In one embodiment the outermost sack, seated substantially below the end flaps 114, is the sack expected to be used most often, while the innermost sack, seated substantially below the first aperture 135 on the package chute 101, is the sack expected to be used least often. By arranging the sacks in said manner, the changing of sacks is more efficient as the whole rolling cart 111 does not need to be pulled out as often. While it is preferred to have an efficient arrangement of sack assignments, it should be appreciated that other embodiments may utilize various sack arrangements. For example, some may be wholly random, while others may be based on the final destination of the contents.

In at least one further embodiment, a robot system is utilized for sack, or other bin/container/destination, changing. Autonomous Mobile Robot (AMR) or Automated Guided Vehicle (AGV) systems may be utilized to substantially automate container changing. In such operation, the robot system may be configured to move below selected package chutes at a selected time, to remove a full container and replace with a new, empty container. As there are four sacks under each package chute of the illustrated embodiment, there may be embodiments that utilize multiple robot paths to prevent the need for all four sacks to be moved if a single sack needs to be changed. For example, a system may utilize a robot path in front of the sack positions configured to move the front two sacks out for changing; a second robot path is behind the sack positions configured to move the rear two sacks out for changing. It should be appreciated that a large variety of robot types and paths may be utilized for purposes of changing out sacks/bins/containers.

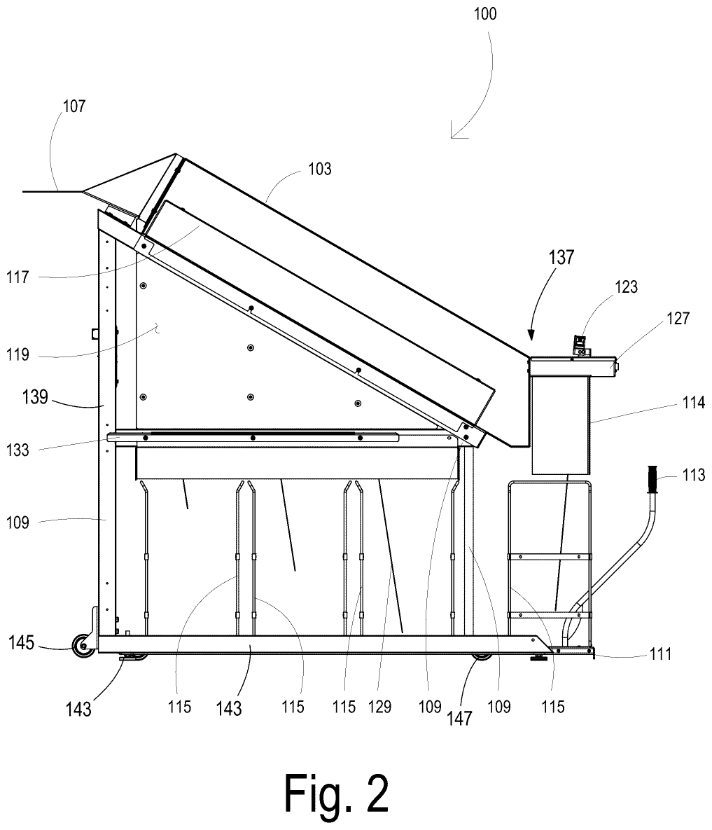

Referring now also to FIG. 2, a side view of the high-density, direct-to-destination output system is illustrated according to the embodiment. FIG. 2 best illustrates the slope and pitch of the output system. Output system 100 preferably has a compact output pitch of 26.4 inches with a downward slope of package chute 101 being approximately 30 degrees. However, it should be appreciated that in additional embodiments, the pitch, slope, and length of the package chute 101, as well as the width/height of the side walls 103 may vary depending on the desired final configuration of the system. For example, in some embodiments, a more gradual slope may be desired such that the downward chute pitch is only 20 degrees, regardless of if the system pitch is changed. Further embodiments may include slope angles exceeding 30 degrees, with the understanding that steeper slopes result in faster package drop speeds.

In the illustrated embodiment, the package chute 101 is not one continuous slope, but rather includes slight drop offsets near each aperture 135 (shown in FIG. 1). The drop offset is approximately five degrees below the main package chute and is positioned such that a tip (FIG. 7) of each flap 105 is seated below the package chute slope. The slight offset provides for a small area of bounce allowed during closing of the flaps 105, without the bounce protruding up into the package path and disturbing flow, or even stopping flow of, the next package through the chute.

FIG. 2 also illustrates the orientation of the sack holders 115. Each of the three sack holders 115 positioned beneath a respective aperture 135 is oriented in a front-to-back position, such that sacks are generally placed and removed from either side. The fourth sack holder 115, positioned near the bottom end 137 of package chute 101, is oriented in a side-to-side position, such that the respective sack may be placed and removed from proximate the outlet 137. Such orientation ideally allows for removal and replacement of sacks from the fourth sack holder without the need for movement of the rolling cart 111. Although preferred to maximize efficiency, it should be appreciated that each sack holder may be positioned or oriented in different manners within other embodiments to fit various desired system designs.

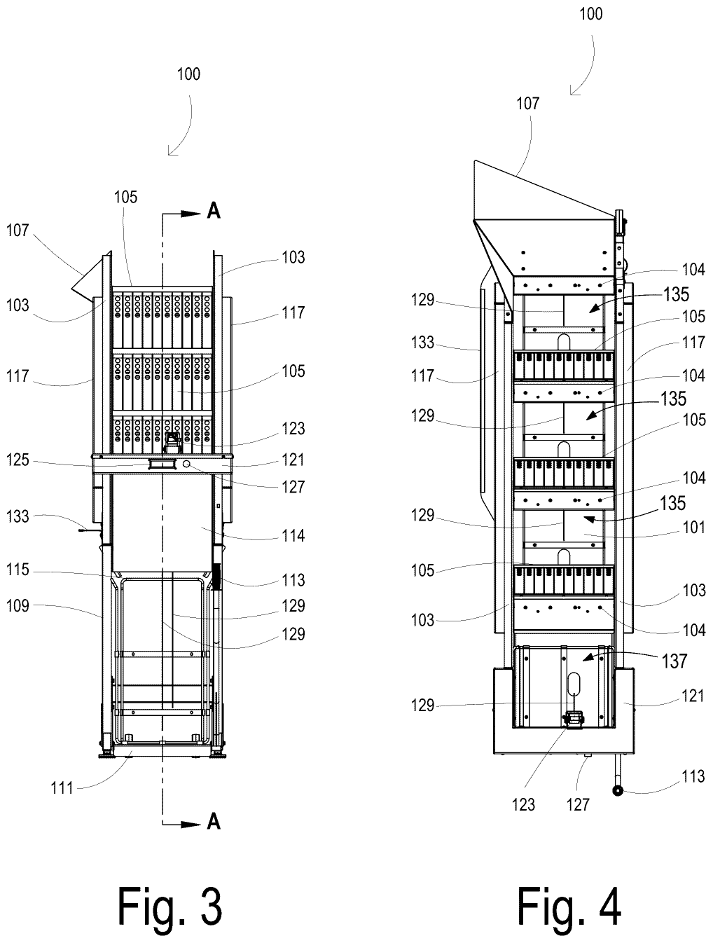

Referring now also to FIG. 3 in the drawings, a front view of the high-density, direct-to-destination output system is illustrated according to the illustrated embodiment. FIG. 3 also includes a reference line A-A for the cross-sectional view of FIG. 5. FIGS. 3 and 4 best illustrates the positioning of the handle 113. Handle 113 is operably associated with the rolling cart 111, such that an operator of the system can pull the handle 113 to move the rolling cart 111 out from underneath the package chute 101. While the handle 113 is illustrated as being a single ergonomic handle disposed in a right-hand position, it should be appreciated that other embodiments may utilize handles of varying shapes, positions, and even the use of a different number of handles, as described above. In some embodiments, as noted above, there may be no handles necessary if an automated system is used to maneuver the rolling cart 111. However, even in some embodiments with an automated system, it may be desirable to include at least one handle in case manual operation is necessary, such as in the event of automated system failure.

Referring now also to FIG. 4, a top view of the high-density, direct-to-destination output system is illustrated according to an embodiment. FIG. 4 provides a clear illustration of the shape and size of some of the components of output system 100. In particular, the shape of bumper 133 and transfer plate 107 are best seen in FIG. 4. As described above, the transfer plate 107 is an angled piece of material configured for aiding in directing packages from a conveyor system (shown in FIG. 6) to the package chute 101. It should be appreciated that other embodiments may include a variety of transfer methods, including replacements for the transfer plate 107 or transfer plates having other shapes.

Referring now also to FIG. 5 in the drawings, a cross-sectional view of the high-density, direct-to-destination output system is illustrated. FIG. 5 best illustrates the internal components of output system 101, such as sensors 123 and dividers 131. Beams 129, also partially seen in FIGS. 1-4, are associated with the sensors 123, with one beam 129 associated with each sensor 123. For example, the sensors 123 are positioned slightly underneath the respective flap 105 to detect the contents of each sack of sack holders 115. In operation, the sensor 123 may detect when a single sack is full, such that it needs to be replaced. Alternatively, the sensors may be positioned to scan up to the bottom of the respective flap 105, such that the sensor detects when the flap 105 is opened, or when a package moves through the associated aperture 135. Each of the sensors 123 and beams 129 operation may be connected to the display 125 or status light 127 to relay operational information that can be indicated to a user of the system. Although illustrated as beams partially reaching downward, it should be appreciated that beams 129 are illustrative and that in practice, beams may not be visible and may not be of consistent length.

FIG. 6 illustrates the package sorting system or conveyor system 600 utilizing a plurality of high-density, direct-to-destination output systems 100. The sorting system 600 is a conveyor-type system designed to carry packages 602 from a loading point to selected sacks held within each output system 100. The sorting system 600 includes a plurality of output systems 100 disposed on one side of the conveyor belt 604. Although the sorting system 600 is illustrated as having two conveyor belts 604 leading to the output systems 100, with a directing member (not shown) configured to push packages 602 onto a selected output system 100, it should be understood and appreciated that other conveyors, or similar sorting systems, may be utilized with the output systems. Further embodiments of the sorting system 600 may include varying numbers and positions of each output system 100, including other angles relative to the conveyor system.

FIG. 7 illustrates a partial exploded view of the flap 105 for use with the high-density, direct-to-destination output system 100. The flap 105 includes a plurality of ribs 701, a plurality of apertures 703, a wing tip 705, and apertures 709. A shaft member 707 is used for actuation of the flap 105, the shaft member 707 having lever arm 711 and shaft ends 713. The apertures 709 are preferably configured to accommodate shaft member 707, with at least one of the apertures 709 being square to account for the square shaft member. The square shaft provides adequate leverage, as well as aiding in prevention of any shaft slipping. The remaining apertures 709 are configured for attachment to the lever arm 711. It should be appreciated that other embodiments may utilize other types of actuating members that may not have the exact aperture configuration or a square shaft member.

The flap 105 is preferably designed with ribs 701 on both top and bottom surfaces of the flap. The ribs 701 aid in maintaining structural strength, while also reducing package drag. The ribs 701 create a gap between the surface and the package, which reduces any suction effect during package movement. Further aiding in structural strength may be aluminum tubes (not shown) interior to the flap 105. The flap 105 is preferably made of an antistatic material, further reducing any drag created by static electricity. Such drag effects are common issues with polybags and other common package materials being slid on surfaces. The apertures 703 disposed near the wing tip 705 cause openings wholly through the wing 105. The apertures 703 aid in reducing aerodynamic drag of the flap 105. It should be appreciated that other embodiments may not utilize some or all of such drag reducing effects; for example, a substantially planar surface with no ribs or apertures may be utilized as a flap.

As detailed above, the wing tip 705 is preferably configured to be seated below a surface of the package chute at approximately five degrees for purposes of preventing package interference upon any bounce up of the flap 105 during a closing maneuver. The square shaft member 707 is configured to cause selected upward and downward movement of the flap 105. Shaft ends 713 are preferably configured for easy access to the shaft for maintenance purposes. For example, the shaft ends 713 hold the shaft in place within the flap 105, but may be removed by simply removing two fasteners, providing access to the shaft for maintenance or other purposes. On one end of the shaft is the lever arm 711, which is configured for attachment to a linear actuator. In the illustrated embodiment, the actuator is a pneumatic cylinder. However, it should be appreciated that further embodiments may utilize other forms of mechanical, electrical, or pneumatic actuation.

It is apparent that a system with significant advantages has been described and illustrated. The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the embodiments are shown above, they are not limited to just these embodiments, but are amenable to various changes and modifications without departing from the spirit thereof.

What is claimed is:

1. A high-density output system, comprising:
a package chute having a selected slope, the package chute including a plurality of apertures and a bottom end;
a frame configured to carry the package chute, the frame having an open area disposed below the package chute;
a plurality of flaps, each flap being associated with one of the plurality of apertures;
a plurality of holders substantially disposed in the open area below the package chute;
a plurality of sensors coupled to the package chute;
wherein each holder is operably associated with at least one of the plurality of apertures or the bottom end of the package chute; and
wherein each flap is configured to be opened at a selected time, such that a package is directed through the associated aperture and into the respective holder.

2. The output system of claim 1, further comprising a rolling cart configured for insertion into the open area below the package chute wherein each of the holders are carried by the rolling cart.

3. The output system of claim 2, further comprising an automated system configured for selectively moving the rolling cart.

4. The output system of claim 1, wherein at least a portion of the plurality of sensors are disposed in at least one sensor bar.

5. The output system of claim 4, wherein the at least one sensor bar is configured to cause actuation of a selected flap from the plurality of flaps upon sensing a package.

6. The output system of claim 1, further comprising:
an end frame coupled to the bottom end of the package chute; and
at least one end flap extending downward from the end frame wherein the at least one end flap is configured to direct packages into one of the holders.

7. The output system of claim 6, further comprising a status light disposed on a surface of the end frame.

8. The output system of claim 6, further comprising a display disposed on a surface of the end frame.

9. The output system of claim 1, wherein one holder is positioned with a side-to-side orientation and the remainder of the holders are positioned with a front-to-back orientation.

10. The output system of claim 1, further comprising a plurality of dividers, each divider configured to partially enclose a path between one of the apertures and the holder associated with the respective aperture.

11. The output system of claim 1, wherein the selected slope is 30 degrees.

12. A system for sorting packages comprising:
a conveyor system for transporting packages; and
a plurality of output systems, each output system comprising;
a package chute having a selected slope, the package chute including a plurality of apertures;
a frame configured to carry the package chute;
a plurality of flaps, each flap corresponding to one of the plurality of apertures;
a plurality of sack holders operably associated with the package chute; and
a plurality of sensors, at least a portion of the sensors being operably associated with the plurality of flaps,
wherein each output system is angled relative to the conveyor system such that packages on the conveyor system are transferred to one of the output systems.

13. The system for sorting packages of claim 12, wherein the plurality of output systems includes at least one output system on a side of the conveyor system.

14. The system for sorting packages of claim 12, wherein each of the plurality of output systems is positioned at a selected angle relative to the conveyor system.

15. The system for sorting packages of claim 14, wherein the selected angle is 68 degrees.

16. The system for sorting packages of claim 12, wherein each of the plurality of output systems further comprises a rolling cart configured to carry each of the plurality of sack holders.

17. A method for sorting packages comprising:
providing a conveyor system;
providing at least one output system, the output system comprising:
a sloped package chute including a plurality of apertures;
a frame configured for carrying the sloped package chute;
a plurality of flaps, each flap being operably associated with one of the plurality of apertures;
a plurality of sack holders operably associated with the package chute; and
a plurality of sensors coupled to the package chute;
providing a plurality of sacks, each sack having a designated sortation category, each sack being placed on one of the sack holders;
providing at least one package to a starting portion of the conveyor system, the at least one package having an end destination associated with one of the designated sortation categories;
directing the package to one of the at least one output systems based upon the end destination;
actuating motion of one of the plurality of flaps based upon an output from the plurality of sensors, such that the flap moves into an open position and the associated aperture is exposed, such that the package is directed downward into the associated sack.

18. The method for sorting packages of claim 17, further comprising arranging the sacks in a selected order, such that the sack expected to receive the most packages is disposed on the sack holder furthest from the conveyor system.

19. The method for sorting packages of claim 17, wherein the at least one output system further comprises a rolling cart configured to carry the sack holders.

20. The method for sorting packages of claim 19, further comprising:
moving the rolling cart outward from underneath the package chute, such that a selected sack may be accessed;
removing the selected sack from the sack holder; and
placing a new sack in the sack holder.
